(19) United States
(12) Patent Application Publication
(10) Pub. No.: US 2026/0192790 A1
(43) Pub. Date: Jul. 9, 2026

(54) Combined service brake and spring brake cylinder with service brake cylinder mounted inside the spring brake cylinder

(71) Applicant: KNORR-BREMSE Systeme für Nutzfahrzeuge GmbH, München (DE)

(72) Inventor: Stéphane Hericher, Basseneville (DE)

(21) Appl. No.: 18/868,245

(22) PCT Filed: May 31, 2023
(86) PCT No.: PCT/EP2023/064561

§ 371 Date: Nov. 22, 2024

(30) Foreign Application Priority Data
Jun. 3, 2022 (EP) 22177219.7

(51) Int. Cl. B60T 17/08; B60T 13/38; B60T 13/58; B60T 13/68

(52) U.S. Cl. CPC B60T 17/083; B60T 13/38; B60T 13/588; B60T 13/683

(57) ABSTRACT

A combined service brake and spring brake cylinder for operating a service brake and a parking brake, comprising a spring brake cylinder including a spring brake cylinder housing, a spring brake piston, and at least one accumulator spring loading the spring brake piston in a direction of application of the parking brake, wherein the spring brake piston is displaceably guided on a radially inner circumferential surface of the spring brake cylinder housing, and the spring brake piston and the spring brake cylinder housing delimit a spring brake chamber which can be pressurized by a parking brake pressure; a separate service brake cylinder; and a service brake piston, at least the service brake piston delimiting a service brake chamber which can be pressurized with a service brake pressure, wherein the service brake cylinder, viewed radially, is arranged inside the spring brake cylinder housing, wherein the service brake piston is connected to a service brake piston rod, wherein the service brake cylinder is pot-shaped and has a cylindrical wall part extending in parallel into the spring brake cylinder housing and a bottom part proximate to the spring brake piston and further connected with the cylindrical wall part, wherein the service brake piston is displaceably guided directly on the radially inner circumferential surface of the cylindrical wall part of the service brake cylinder, and wherein the bottom part of the service brake cylinder is provided with a central opening through which the service brake piston rod projects.

### BACKGROUND AND SUMMARY

The present invention relates to combined service brake and spring brake cylinders, and to a pneumatic or electro-pneumatic vehicle brake comprising at least one combined service brake and spring brake cylinder.

Combined pneumatic service brake and spring brake cylinders with a service brake function and a parking brake function are usually arranged on rear axles of commercial vehicles and usually have two compressed air ports. One compressed air port controls the parking brake function and is under a parking brake release pressure for compressing an accumulator spring of the spring brake cylinder when the commercial vehicles are in a driving state. The other compressed air port controls the service brake function and is vented in the driving condition to brake the commercial vehicle via the service brake. If the commercial vehicle is to be parked, the spring brake cylinder is released and the parking brake is applied via the spring tension of the accumulator spring.

A combined service brake cylinder and spring brake cylinder is known, for example, from DE 10 2014 002 112 A1. There, the spring brake cylinder and the service brake cylinder are arranged coaxially one behind the other and connected to each other by an intermediate flange. However, such an arrangement requires a relatively long installation space within the wheel arches of the commercial vehicles, which can cause space problems.

In order to solve this problem, a combined service brake cylinder and spring brake cylinder is proposed in DE 10 2014 002 112 A1, in which the service brake cylinder and the spring brake cylinder are placed laterally next to one another, the accumulator spring being arranged there around the service brake cylinder. In this case, the service brake piston is guided within the spring brake piston and axially thereon, which has a radially inwardly extending circumferential edge which abuts against an end-face annular surface of the service brake piston in order to drive the service brake piston together with the service brake piston rod into the applied position when the parking brake is applied. However, this arrangement has some disadvantages. Firstly, the radially inwardly extending peripheral edge of the spring brake piston is loaded by the service brake pressure in the service brake chamber, so that during service braking a force is generated at the spring brake piston directed against the spring brake release pressure in the spring brake chamber, which loads the spring brake piston in the application direction of the parking brake. Secondly, the effective area of the spring brake piston on which the parking brake release pressure can act to hold the parking brake released is relatively small, resulting in a high required parking brake release pressure or a low spring stiffness of the accumulator spring, but with disadvantages in terms of compressed air consumption or parking brake force.

Therefore, it is the object of the present invention to provide a short and stiff design combined service brake and spring brake cylinder having a low compressed air consumption and parking and service brake functions which are unaffected by each other. Likewise, to provide a pneumatic or electro-pneumatic vehicle brake having at least one such combined service brake and spring brake cylinder.

This object is solved with the features of the claims of this application. Advantageous further embodiments are the subject of the subclaims.

### DISCLOSURE OF THE INVENTION

The invention is based on a combined service brake and spring brake cylinder for operating a service brake and a parking brake, comprising: a) a spring brake cylinder with a spring brake cylinder housing, a spring brake piston and at least one accumulator spring loading the spring brake piston in a direction of application of the parking brake, wherein the spring brake piston is displaceably guided on a radially inner circumferential surface of the spring brake cylinder housing, and the spring brake piston and the spring brake cylinder housing delimit a spring brake chamber which can be pressurized by a parking brake pressure, b) a separate service brake cylinder and a service brake piston, at least the service brake piston delimiting a service brake chamber which can be pressurized with a service brake pressure, wherein c) the service brake cylinder, viewed radially, is arranged inside the spring brake cylinder housing, wherein d) the service brake piston is connected to a service brake piston rod.

That the service brake cylinder, when viewed radially, is disposed within the spring brake cylinder may mean that the service brake cylinder, when viewed radially, is disposed completely within and enclosed by the wall of the spring brake cylinder. Further, it may mean that the service brake cylinder, when viewed axially, is disposed partially or completely within the spring brake cylinder. “Radial” and “axial” refer in particular to a common longitudinal axis of the combined service brake cylinder and spring brake cylinder, wherein the service brake cylinder and the spring brake cylinder are arranged in particular coaxially.

Furthermore, a spring brake cylinder housing of the spring brake cylinder may comprise a closed housing of the spring brake cylinder, in which the service brake cylinder is then completely accommodated, for example.

According to a first aspect of the invention it is provided that e) the service brake cylinder is pot-shaped and has a cylindrical wall part extending in parallel into the spring brake cylinder housing and a first bottom part connected with the cylindrical wall part, where f) the service brake piston is displaceably guided directly on the radially inner circumferential surface of the cylindrical wall part of the service brake cylinder, and where g)
the first bottom part of the service brake cylinder is provided with a central opening through which the service brake piston rod projects.

According to a second aspect of the invention it is provided that e) the service brake cylinder is pot-shaped and has a cylindrical wall part extending in parallel into the spring brake cylinder housing and a second bottom part connected with the cylindrical wall part, where f) the service brake piston is displaceably guided directly on the radially inner circumferential surface of the cylindrical wall part of the service brake cylinder, and where g) the second bottom part of the service brake cylinder forms a bottom of the spring brake cylinder housing.

“Guided directly” should mean here, for example, that a radially outer circumferential surface of the service brake piston is guided on the radially inner circumferential surface of the cylindrical wall part of the service brake cylinder. In this case, a sealing element is preferably arranged therebetween, which, in addition to a sealing function, then also performs a guiding function for the service brake piston.

With such an arrangement, the combined service brake and spring brake cylinder is short on the one hand, because the service brake cylinder is arranged radially and particularly also axially and particularly completely inside the spring brake cylinder.

On the other hand, the disadvantages of the prior art described above with regard to an influence of the spring brake piston by the service brake pressure present in the service brake chamber are thereby avoided, because the service brake piston is guided directly on a radially inner circumferential surface of the service brake cylinder in a displaceable manner or because a diaphragm cooperating with the service brake piston is attached to the service brake cylinder and/or to the spring brake cylinder.

Last but not least, the spring brake piston can then also have a larger effective area in relation to the parking brake pressure, so that the pressure level of the parking brake release pressure and thus also the energy consumption can be reduced. The parking brake release pressure is the pressure at which the parking brake releases against the action of the at least one accumulator spring.

The service brake piston which is connected to the service brake piston rod actuates the service brake when the service brake chamber is pressurized by the service brake pressure and which releases the service brake when the service brake chamber is vented or depressurized. In particular, the service brake piston rod can be formed by a cylindrical or rod-shaped body, to the end of which the service brake piston projecting radially outwards from this end is then attached.

As the service brake cylinder according to both aspects of the invention is pot-shaped and has the cylindrical wall part extending parallel into the spring brake cylinder and the first or second bottom part, where the service brake piston is guided for displacement directly on the radially inner circumferential surface of the cylindrical wall part of the service brake cylinder, the design of the service brake cylinder is stiffer. Particularly, the cylindrical wall part and the first bottom part or the second bottom part are formed as a one piece. Further to this, the first or second bottom parts are multifunctional and also used for guiding the service brake piston rod by the first bottom part and covering the spring brake cylinder housing by the second bottom part.

According to a preferred embodiment of the first aspect, the service brake chamber is delimited by the service brake piston, by the cylindrical wall part of the service brake cylinder and by a first cover of the spring brake cylinder.

According to a further preferred embodiment of the first aspect, there is a first actuating element of an emergency release device which protrudes a central opening of the first cover.

According to a further preferred embodiment of the first aspect, the first cover is provided with an air port for the service brake chamber.

A particularly short combined service brake and spring brake cylinder results according to a further preferred embodiment of the first aspect, if preferably in the release position of the parking brake, i.e. in particular with a pressurized spring brake chamber, the spring brake piston contacts the first bottom part of the service brake cylinder, in particular with its side facing away from the spring brake chamber.

According to a further preferred embodiment of the first aspect, a first return spring chamber which houses a return spring which loads the service brake piston into the service brake release position is formed between the service brake piston and the first bottom part of the service brake cylinder.

According to a preferred embodiment of the second aspect, the service brake chamber is delimited by the service brake piston, by the cylindrical wall part of the service brake cylinder, and by the second bottom part of the service brake cylinder.

According to a further embodiment of the second aspect, the service brake piston contacts the second bottom part of the service brake cylinder in the service brake release position, where the service brake is released.

According to a further embodiment of the second aspect, a second return spring chamber which houses a return spring which loads the service brake piston into the service brake release position is formed between the service brake piston and the spring brake piston.

According to a further embodiment of the second aspect, there is a first actuating element of an emergency release device which protrudes a central opening of the second bottom part of the of the service brake cylinder.

According to a further embodiment of the second aspect, the at least one accumulator spring is supported on one side on the spring brake piston and on the other side on the second bottom part of the service brake cylinder.

According to a further embodiment of the second aspect, the second bottom part of the service brake cylinder is provided with an air port for the service brake chamber.

According to a preferred embodiment of the first and second aspect, the service brake piston rod actuates the service brake when the service brake chamber is pressurized and which releases the service brake when the service brake chamber is depressurized or vented.

According to a preferred embodiment of the first and second aspect, a first (free) end of the cylindrical wall part of the service brake cylinder is particularly formed by an edge and a second end of the cylindrical wall part is connected with the first or second bottom part.

According to a preferred embodiment of the first and second aspect, the (free) edge at the first end of the cylindrical wall part of the service brake cylinder is connected with the spring brake cylinder housing.

According to a preferred embodiment of the first and second aspect, the spring brake piston has a central opening with a bearing through which the spring brake piston is axially guided on the service brake piston rod and/or through which the service brake piston rod and the spring brake piston are axially displaceable relative to one another.

According to a preferred embodiment of the first and second aspect, the service brake piston rod has, in particular on its radially outer circumference, a radial projection which forms an axial stop for the spring brake piston.

According to a preferred embodiment of the first and second aspect, the radial projection is arranged and formed on the service brake piston rod in such a way that a) the spring brake piston brings the service brake piston rod into the applied position of the parking brake by abutment against the radial projection when the spring brake chamber is vented or depressurized, and/or in that b) the radial projection comes out of engagement with the spring brake piston and thereby the service brake piston rod is brought into the applied position of the service brake when the spring brake chamber and the service brake chamber are pressurized, and/or that c) the spring brake piston by abutting against the radial projection and the service brake piston bring the service brake piston rod into the applied position of the parking brake and the service brake when the spring brake chamber is vented or depressurized and when the service brake chamber is pressurized.

According to a preferred embodiment of the first and second aspect, the spring brake piston, seen radially, extends from the central opening beyond a radially outer circumferential surface of the service brake cylinder to the radially inner circumferential surface of the spring brake cylinder. Then, a particularly large effective area of the spring brake piston with respect to the parking brake release pressure is achieved.

According to a preferred embodiment of the first and second aspect, between the radially outer circumferential surface of the service brake cylinder, particularly of the cylindrical wall part of it, and the spring brake cylinder a spring chamber is formed as an annular chamber in which the at least one accumulator spring is arranged.

According to a preferred embodiment of the first and second aspect, a breathing device is provided comprising at least a breathing valve which is arranged in a through-opening of the service brake piston and is controlled by the service brake pressure in the service brake chamber in such a way that it assumes an open position when the service brake chamber is vented or depressurized, in which a first flow connection between the service brake chamber and the return spring chamber is open, and it is brought from the open position into a closed position, in which the first flow connection is blocked, when the service brake chamber is pressurized.

According to a preferred embodiment of the first and second aspect, the breathing valve comprises a valve seat and a valve body biased by spring means away from the valve seat into the open position of the breathing valve, which valve body is urged against the valve seat by the service brake pressure against the action of the spring means to move the breathing valve from the open position to the closed position.

According to a preferred embodiment of the first and second aspect, the breathing device comprising further a second flow connection between the return spring chamber and the spring chamber and a third flow connection between the spring chamber and the atmosphere.

For example, the second flow connection may comprise a through opening in the cylindrical wall part or in the first or second bottom part of the service brake cylinder.

For example, the third flow connection may comprise a through opening in a wall or a cover of the spring brake cylinder. Also, the third flow connection may comprise a filter and/or a valve that prevents dirt and moisture from entering the spring brake cylinder from the outside.

According to a preferred embodiment of the first and second aspect, when the service brake chamber is pressurized, the volume of the return spring chamber is reduced and thereby a first air flow is generated which passes the second flow connection and the third flow connection.

According to a preferred embodiment of the first and second aspect, the when the spring brake chamber is pressurized, the volume of the spring chamber is reduced and thereby a second air flow is generated which passes through the third flow connection or through the first flow connection.

According to a preferred embodiment of the first and second aspect, the when the spring brake chamber is vented or depressurized, the volume of the spring chamber increases and thereby a third air flow is generated which passes through the first flow connection and the second flow connection.

The operation of the breathing device may then be described by way of example as follows:

For example, when the service brake chamber is pressurized, the breathing valve assumes the closed position so that no compressed air can pass from the service brake chamber into the return spring chamber. On the other hand, the moving service brake piston reduces the volume of the return spring chamber, thereby creating the first air flow which then passes through the second flow connection and the third flow connection to enter the atmosphere. Then, no excess pressure in the return spring chamber can impede the movement of the service brake piston in the service brake application direction.

On the other hand, when the spring brake chamber is pressurized to release the parking brake, the volume of the spring chamber is reduced, thereby creating the second air flow which can then pass through the third flow connection or through the first flow connection to enter the atmosphere. Then, no excess pressure in the spring chamber can impede the movement of the spring brake piston in the parking brake release direction.

According to a preferred embodiment of the first and second aspect, there is a second actuating element at a first end of the service brake piston rod, that extends through an opening of the spring brake cylinder housing or through a second cover of the spring brake cylinder housing, wherein the second actuating element is provided to actuate a brake caliper and wherein a second end of the service brake piston rod is connected to the service brake piston.

According to a preferred embodiment of the first and second aspect, the second actuating element, particularly formed as pusher, is pivotally received in a recess at the first end of the service brake piston rod. The pusher can be spring-loaded in a center position. Further, the spring can be a conical spring that spring-loads the pusher in a specific position. This specific position is a position in which the pusher can come into operative contact with an actuating member of the brake caliper to actuate the brake caliper.

According to a third aspect of the invention, a pneumatic or electro-pneumatic vehicle brake comprises at least one combined service brake and spring brake cylinder according to the description above.

Advantageous further embodiments of the invention are apparent from the claims, the description and the drawings. The advantages of features and of combinations of several features mentioned in the introduction to the description are merely exemplary and can have an effect alternatively or cumulatively, without the advantages necessarily having to be achieved by embodiments according to the invention. Further features can be found in the drawings—in particular the geometries shown and the relative dimensions of several components to one another, as well as their relative arrangement and effective connection. The combination of features of different embodiments of the invention or of features of different patent claims is also possible in deviation from the chosen back relationships of the patent claims and is hereby suggested. This also applies to such features which are shown in separate drawings or are mentioned in the description thereof. These features may also be combined with features of different patent claims. Likewise, features listed in the patent claims may be omitted for further embodiments of the invention.

### DETAILED DESCRIPTION OF THE DRAWINGS

A preferred embodiment of the invention is shown below in the drawing and will be explained in more detail in the following description. The drawing shows

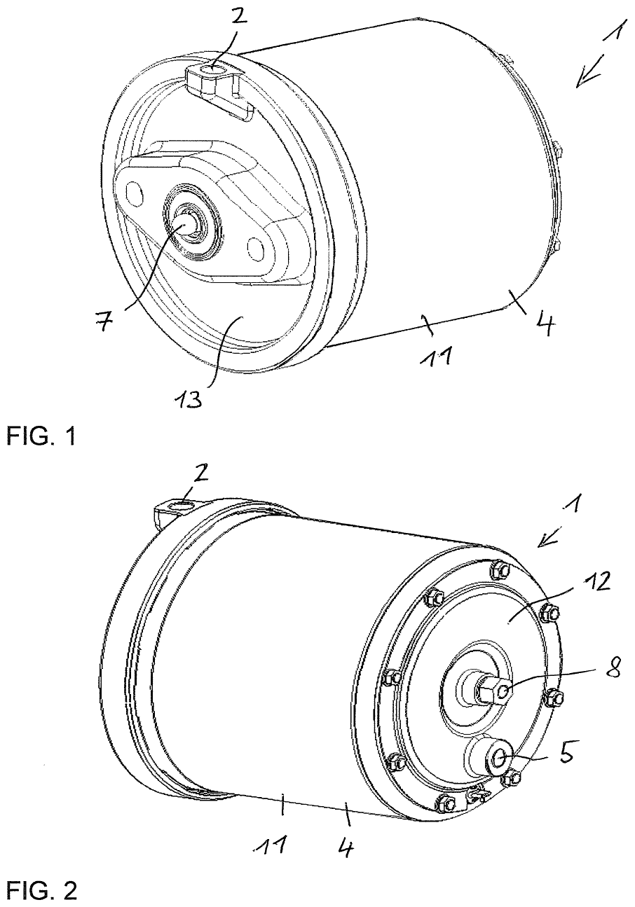

FIG. 1 a perspective view of a preferred embodiment of a combined service brake and spring brake cylinder of an electro-pneumatic brake system of a commercial vehicle according to a first aspect, looking at the one end face from which an actuating element for a disc brake can be seen;

FIG. 2 a perspective view of the combined service brake and spring brake cylinder of FIG. 1, looking at the other end face from which an actuating element of an emergency release device protrudes;

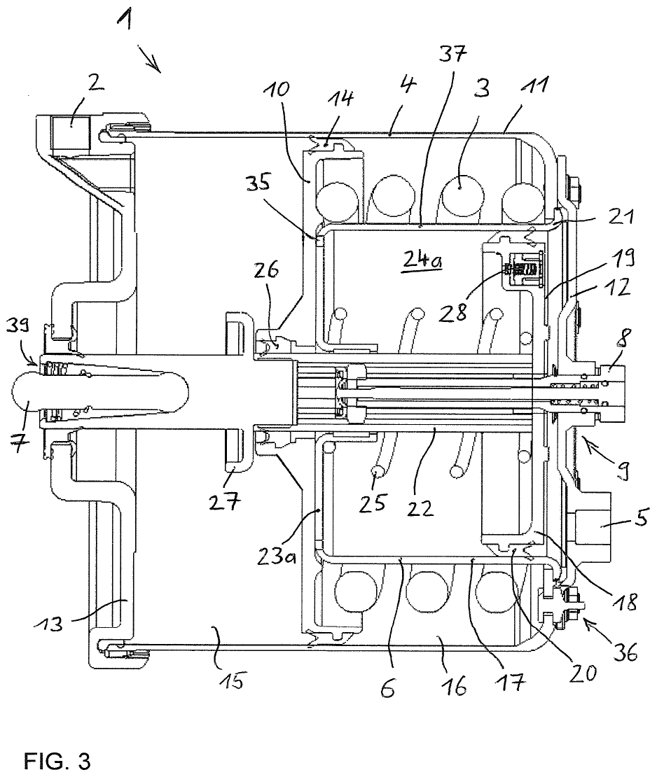

FIG. 3 a cross-sectional view of the combined service brake and spring brake cylinder of FIG. 1 and FIG. 2 in a situation in which the parking brake and the service brake are released, in particular during a driving condition of the commercial vehicle;

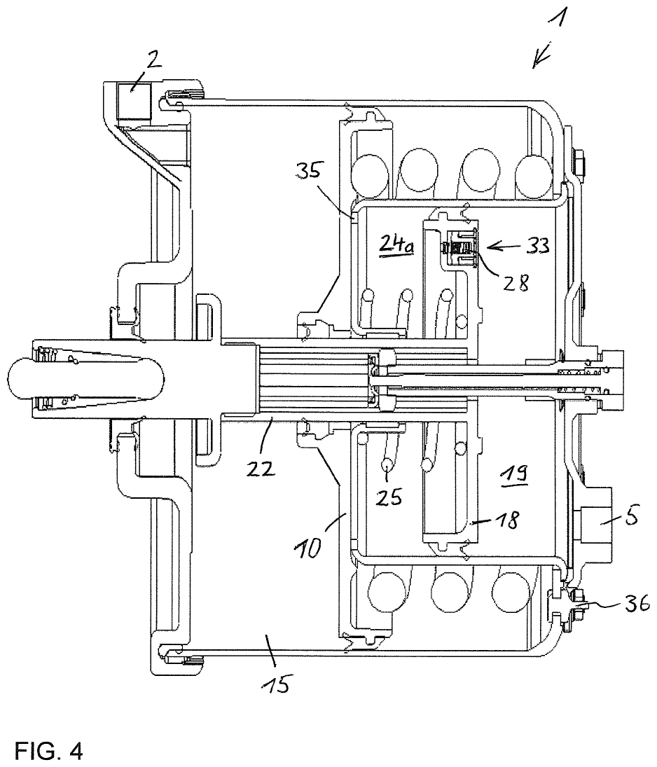

FIG. 4 a cross-sectional view of the combined service brake and spring brake cylinder of FIG. 1 and FIG. 2 in a situation in which the parking brake is released and the service brake is applied, in particular during a driving condition of the commercial vehicle;

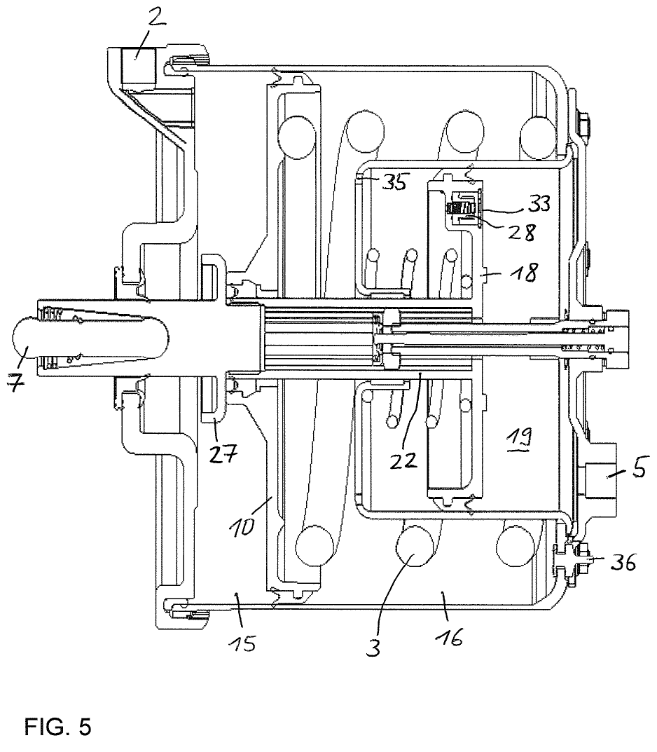

FIG. 5 a cross-sectional view of the combined service brake and spring brake cylinder of FIG. 1 and FIG. 2 in a situation in which the parking brake is applied, in particular during the production of a parking condition of the commercial vehicle;

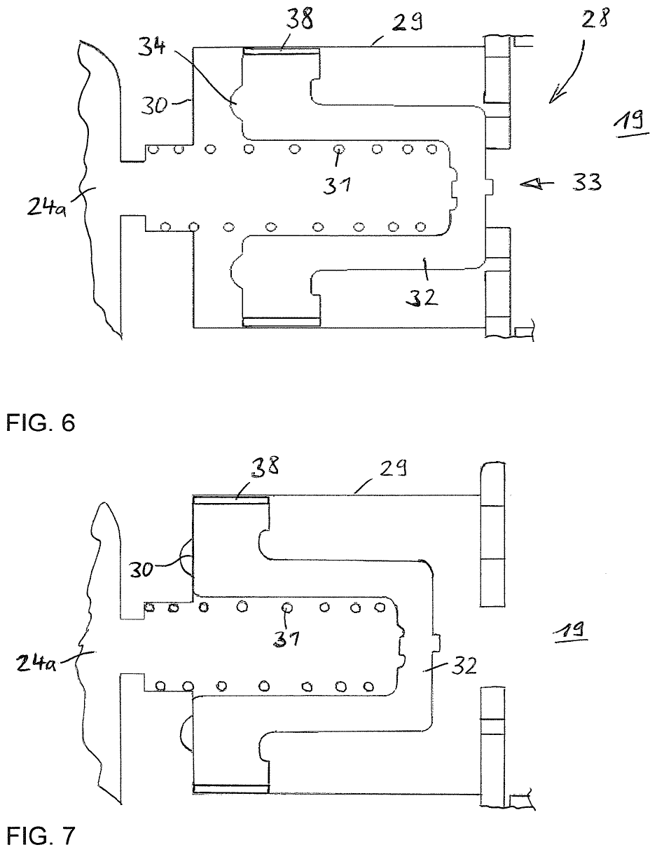

FIG. 6 a cross-sectional view of a breathing valve of a combined service brake and spring brake cylinder in an open position;

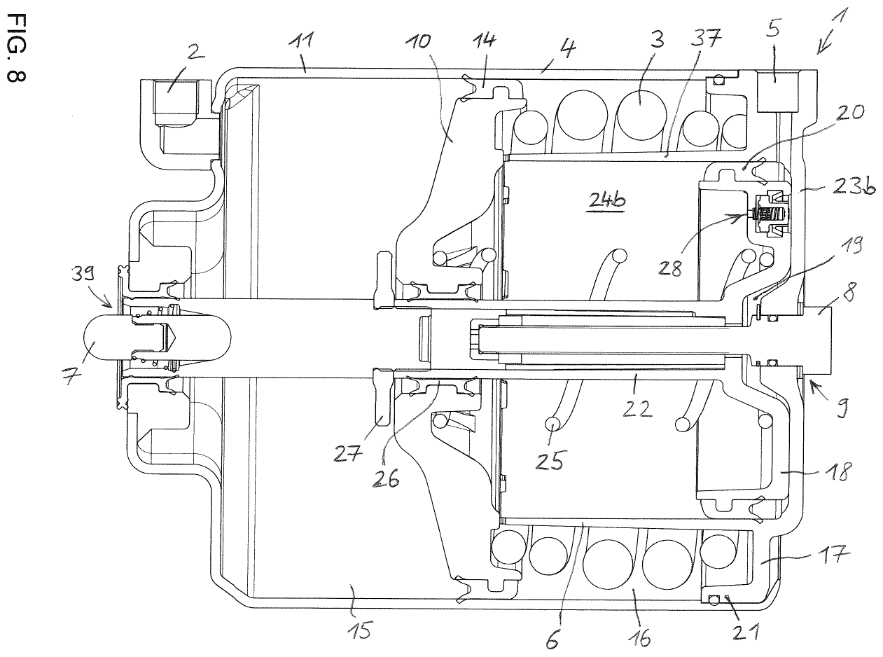

FIG. 7 a cross-sectional view of a breathing valve of FIG. 6 in a closed position;

FIG. 8 a cross-sectional view of a preferred embodiment of a combined service brake and spring brake cylinder of an electro-pneumatic brake system of a commercial vehicle according to a second aspect.

### DESCRIPTION OF THE PREFERRED EMBODIMENTS

The combined pneumatic service brake and spring brake cylinder 1 having a service function and a parking brake function as described hereinafter is usually arranged on a wheel of a rear axle of commercial vehicles and usually has two compressed air ports 2, 5. A first compressed air port 2 controls the parking brake function and, in the driving state of commercial vehicles, is under a parking brake release pressure for compressing an accumulator spring 3 of a spring brake cylinder 4. A second compressed air port 5 controls the service brake function and, particularly in the driving state, can be pressurized to brake the commercial vehicle via the service brake. In this case, the service brake function is carried out by means of a service brake cylinder 6 designed as a brake piston cylinder. If the commercial vehicle is to be parked, the spring brake cylinder 4 is vented or depressurized and the parking brake is applied via the spring tension of the accumulator spring 3.

In an electro-pneumatic brake system, for example, the pressure for the two compressed air ports 2, 5 is generated by a solenoid valve device not shown here, which is supplied with compressed air under supply pressure from at least one compressed air supply. For coordinated control or regulation of the service brake pressure or parking brake pressure introduced into the two compressed air ports 2, 5, the solenoid valve device is controlled by an electronic control system.

FIG. 1 shows a perspective view of a preferred embodiment of a combined service brake and spring brake cylinder 1 of an electro-pneumatic brake system of a commercial vehicle according to a first aspect of the invention, looking at one end face from which a second actuating element 7 for actuating for example a brake caliper of a disc brake, can be seen. FIG. 2 represents a perspective view of the combined service brake and spring brake cylinder 1 of FIG. 1, looking at the other end face from which a first actuating element 8 of an emergency release device 9 protrudes.

As shown in FIG. 3, which is a cross-sectional view of the service brake and spring brake cylinder 1 of FIG. 1 and FIG. 2 in a situation in which the parking brake and the service brake are released, in particular during a driving condition of the commercial vehicle, the combined service brake and spring brake cylinder 1 comprises the spring brake cylinder 4, a spring brake piston 10 axially slidably guided therein, and the accumulator spring 3 loading the spring brake piston 10 in an applied position of the parking brake.

The spring brake cylinder 4 comprises a substantially cylindrical spring brake cylinder housing 11 with here, for example, two covers 12, 13 attached to the end faces, a first cover 12 and a second cover 13, wherein the second actuating element 7 for the disc brake projects from a central through-opening of a second cover 13 and the first actuating element 8 of the emergency release device 9 projects from a central through-opening of a first cover 12. Alternatively, the spring brake cylinder housing 11 could also be pot-shaped and then have, for example, only one cover. Generally, the spring brake cylinder housing 11 forms a closed housing of the spring brake cylinder 4, in which the service brake cylinder 6 is for example completely included. Further, the service brake cylinder 6 or a service brake cylinder housing 17 of the service brake cylinder 6 is preferably a separate part of the combined service brake and spring brake cylinder 1.

The spring brake piston 10 is axially displaceably guided on a radially inner circumferential surface of the spring brake cylinder 4 or of the spring brake cylinder housing 11, wherein a first movement seal 14 is arranged between a radially outer edge of the spring brake piston 10 and the radially inner circumferential surface of the spring brake cylinder 4 or of the spring brake cylinder housing 11, a first movement seal 14 is arranged which is connected here to the radially outer edge of the spring brake piston 10 and which, in addition to a sealing function, also performs a guide function for the spring brake piston 10.

With its one side facing away from the accumulator spring 3, the spring brake piston 10 delimits a spring brake chamber 15 which can be pressurized and vented or depressurized by a parking brake pressure via the first compressed air port 2. The accumulator spring 3 is then supported with its one end on the other side of the spring brake piston 10, the other end of which is supported on the spring brake cylinder housing 11. The first compressed air port 2 is formed, for example, in the second cover 13. However, it could also be formed in a bottom of the spring brake cylinder or of the spring brake cylinder housing 11 of the spring brake cylinder 4, if the spring brake cylinder housing 11 is pot-shaped, for example.

The accumulator spring 3 is then accommodated in a spring chamber 16 which is formed here as an annular chamber and is radially outer with respect to the service brake cylinder 6, and which is limited or bounded radially inwardly by a radially outer circumferential surface of the service brake cylinder housing 17 of the service brake cylinder 6 and radially outwardly by the radially inner circumferential surface of the spring brake cylinder housing 11. Axially, the spring chamber 16 is limited or bounded by the spring brake piston 10 and the spring brake cylinder housing 11.

A cylindrical wall part 37 of the service brake cylinder 6 or of the service brake cylinder housing 17 directly guides an axially displaceable service brake piston 18, the service brake cylinder 6 or the service brake cylinder housing 17 and the service brake piston 18 delimiting a service brake chamber 19 which can be pressurized and vented or depressurized with a service brake pressure via the second compressed air port 5.

The service brake cylinder 6 or the service brake cylinder housing 17 of the service brake cylinder 6 is arranged radially and here, for example, also axially, preferably completely within the spring brake cylinder 4 or within the spring brake cylinder housing 11 of the spring brake cylinder 4. Further, the service brake piston 18 is axially slidably guided directly on the radially inner peripheral surface of the cylindrical wall part 37 of the service brake cylinder 6 or of the service brake cylinder housing 17. This direct guidance includes that a second movement seal 20 is arranged therebetween, which here is connected to the radially outer edge of the service brake piston 18 in addition to a sealing function also performs a guiding function for the service brake piston 18.

According to a further embodiment not shown here, a diaphragm cooperating with the service brake piston 18 may, for example, be attached with its radially outer edge to the service brake cylinder 6 and/or to the spring brake cylinder 4. The service brake cylinder 6 is then a so-called diaphragm cylinder. In this case, the service brake piston 18, which is then smaller in its radial extension, forms a pressure plate, for example a central pressure plate, on which the diaphragm acts, is connected with or on which the diaphragm is supported. The diaphragm may, for example, be secured to or in a joint between the service brake cylinder 6 and the spring brake cylinder 4. It is conceivable, for example, that a radially outer edge of the diaphragm is clamped between the service brake cylinder 6 and the spring brake cylinder 4. With reference to FIG. 3, the radially outer edge of the diaphragm may be clamped between the first cover 12 of the spring brake cylinder 4 and an edge 21 provided at one end of the cylindrical wall part 37 of service brake cylinder 6, which is pot-shaped. Further to this cylindrical wall part 37, the pot-shaped service brake cylinder 6 comprises a first bottom part 23a which is connected with the other and of the cylindrical wall part 37.

In both embodiments, the service brake piston 18 is connected to a service brake piston rod 22, which is made hollow here, for example, to receive the emergency release device 9 in its interior. The service brake piston rod 22 then actuates the service brake via the second actuating element 7, particularly a pusher which is pivotally received in a recess 39 at the first end of the service brake piston rod 22, when the service brake chamber 19 is pressurized with a service brake application pressure, and which releases the service brake when the service brake chamber 19 is vented. The end of the service brake piston rod 22 facing the service brake chamber 19 can then project radially outwardly away from the service brake piston rod 22 in a mushroom-like manner. Further, if the pusher 7 is pivotally received in the recess 39 at the first end of the service brake piston rod 22, the pusher 7 can follow the movement of a lever of a brake caliper through deflection movement. The pusher 7 can be spring-loaded in a center position.

The second compressed air port 5, which is formed for example in the first cover 12, is then used for pressuring/venting the service brake chamber 19. As indicated above, the emergency release device 9 for manual emergency release of the combined service brake and spring brake cylinder 1, which is not described in detail here, may be accommodated or integrated in the service brake piston rod 22. By turning the second actuating element 8 projecting from the combined service brake and spring brake cylinder 1, the service brake piston rod 22 can then be screwed into the release position of the parking brake or the service brake. Such manual emergency release is necessary in particular if no more parking brake release pressure can be generated in the spring brake chamber 15, for example, due to an electrical defect in the solenoid valve device or in its control system or also in the event of a power failure.

As already mentioned above, the service brake cylinder 6 or the service brake cylinder housing 17 is of pot-shaped design and has the cylindrical wall part 37 extending in parallel into the spring brake cylinder 4 or into the spring brake cylinder housing 1, and a first bottom part 23a. The first bottom part 23a is provided, for example, with a central opening through which the service brake piston rod 22 then projects into the spring brake cylinder 4 or into the spring brake chamber 15. Furthermore, the service brake piston rod 22 penetrates the spring brake chamber 15 centrally and then receives the second actuating element 7 for the caliper of the disc brake in a recess 39 at its end facing the caliper of the disc brake and projecting out of the spring brake cylinder housing 11 through the through-opening.

A first return spring chamber 24a is formed here between the service brake piston 18 and the first bottom part 23a of the service brake cylinder 6, with a return spring 25 which loads the service brake piston 18 into the service brake release position. Also, the first return spring chamber 24a is penetrated axially and centrally by the service brake piston rod 22.

As explained above, the pot-shaped service brake cylinder 6 has the free edge 21 which is fixed to the spring brake cylinder 4, in particular in the region of the fixing of the end-face first cover 12 to the spring brake cylinder 4, whereby this first cover 12 also delimits or closes the service brake chamber 19. Then, the service brake chamber 19 which can be pressurized and depressurized is delimited by the cylindrical wall part 37 of the service brake cylinder housing 17, the first cover 12 of the spring brake cylinder 4 and the service brake piston 18 or, alternatively, by the above-mentioned diaphragm in the case a the above-mentioned diaphragm cylinder used as the service brake cylinder 6.

As preferably shown in FIG. 3, in the parking brake release position, i.e. when the spring brake chamber 15 is pressurized, the spring brake piston 10 contacts the first bottom part 23a of the service brake cylinder 6 from the outside with respect to the service brake cylinder 6 with its side facing away from the spring brake chamber 15. This contact is caused by the parking brake release pressure acting on the spring brake piston 10.

For example, the spring brake piston 10 includes a central opening having a bearing 26 through which the spring brake piston 10 is axially guided on the service brake piston rod 22. The bearing 26 therefore allows the service brake piston rod 22 and the spring brake piston 10 to move axially relative to each other. The bearing 26 is designed, for example, as a sealing bearing.

The spring brake piston 10 then extends, viewed radially, from the bearing 26 or from the central opening of the spring brake piston 10 beyond a radially outer circumferential surface of the service brake cylinder 6 or of the service brake cylinder housing 17 to the radially inner circumferential surface of the spring brake cylinder 4 or of the spring brake cylinder housing 11. The effective surface of the spring brake piston 10 on which the parking brake pressure or the parking brake release pressure acts is located on the side of the spring brake piston 10 facing the spring brake chamber 15 and then also extends from the bearing 26 or from the central opening of the spring brake piston 10 to the radially inner circumferential surface of the spring brake cylinder 4 or of the spring brake cylinder housing 11. The effective surface of the spring brake piston 10 on which the parking brake pressure or the parking brake release pressure acts is located on the side of the spring brake piston 10 facing the spring brake chamber 15. The effective surface of the spring brake piston 10 also extends from the bearing 26 or from the central opening of the spring brake piston 10 beyond the radially outer circumferential surface of the service brake cylinder 6 or of the service brake cylinder housing 17 to the radially inner circumferential surface of the spring brake cylinder 4 or of the spring brake cylinder housing 11.

As also shown in FIG. 3, the service brake piston rod 22 has, in particular at its radially outer periphery, a radial protrusion 27 which forms an axial stop for the bearing 26 or for the central opening of the spring brake piston 10. This radial protrusion 27 is arranged on the service brake piston rod 22, for example, in such a way that the spring brake piston 10 brings the service brake piston rod 22 into the spring brake application position by abutting against the radial protrusion 27 when the spring brake chamber 15 is vented to apply the parking brake, as shown in FIG. 5. It is immaterial whether the service brake chamber 19 is additionally pressurized to bring the service brake piston rod 22 into the applied position of the service brake, because the service brake piston rod 22 has already moved into the applied position as a result of the release of the accumulator spring 3. However, in order not to overload the disc brake mechanism, parallel application of the parking brake and the service brake may be undesirable.

On the other hand, the radial protrusion 27 of the service brake piston rod 22 comes out of contact or engagement with the spring brake piston 10 when the service brake piston rod 22 is brought into the applied position of the service brake by pressurizing the service brake chamber 19, when at the same time the spring brake chamber 15 continues to be pressurized the parking brake is thereby released. This condition is shown in FIG. 4.

Further, by abutting against the radial protrusion 27, the spring brake piston 10, together with the service brake piston 18, can move the service brake piston rod 22 to the spring brake application position and the service brake application position when the spring brake chamber 15 is vented and when the service brake chamber 19 is pressurized, as can be readily imagined with reference to FIG. 5. Therefore, the service brake piston rod 22 connected to the service brake piston 18 and acting axially on the second actuating element 7 that actuates both the service brake and the parking brake respectively by applying the disc brake.

Particularly preferably, a breathing device is also provided, which comprises, for example, a breathing valve 28 which is arranged here, for example, in a through-opening of the service brake piston 18 and is controlled by the service brake pressure in the service brake chamber 19.

As can be seen from FIG. 6 and FIG. 7, the breathing valve 28 may comprise, for example, a valve seat 30 formed in a valve body 29 and a valve body 32 biased by a spring 31 away from the valve seat 30 into the open position of the breathing valve 28, the valve body 32 being urged against the valve seat 30 by the service brake pressure acting on it against the force of the spring 31 to move the breathing valve 28 from the spring biased open position to the closed position. FIG. 6 then shows the open position and FIG. 7 the closed position of the breathing valve 28.

When the service brake chamber 19 is depressurized, the breathing valve 28 can then assume the open position in which a first flow connection 33 through the through opening between the service brake chamber 19 and the first return spring chamber 24a is open due to the bias of the spring 31. When the service brake chamber 19 is pressurized, the breathing valve 28 is then moved from the open position to the closed position in which the first flow connection 33 through the through opening is blocked because the flow caused by the service brake pressure first passes through a radially outer gap 38 between the valve body 32 and the valve base body 29, and then also passes through the through opening in the service brake piston. However, after some time, i.e. in a transition phase, the pressure exerted on the valve body 32 becomes so great that a sealing portion 34 of the valve body 32 comes into contact with the valve seat 30, thereby closing the first flow connection 33 or the through-opening. This prevents compressed air from then still flowing from the service brake chamber 19 into the first return spring chamber 24a.

Furthermore, a second flow connection 35 between the first return spring chamber 24a and the spring chamber 16, as well as a third flow connection 36 between the spring chamber 16 and the atmosphere can be components of the breathing device.

For example, the second flow connection 35 may comprise a through opening in the cylindrical wall 37 or in the bottom 23 of the service brake cylinder 6 or the service brake cylinder housing 17. Furthermore, the third flow connection 36 indicated in FIG. 1 may comprise a through opening in the spring brake cylinder housing 11, in particular a through opening on the front side. Consequently, the second flow connection 35 and the third flow connection 36 open into the spring chamber 16 here and also communicate with each other through the spring chamber 16.

Also, the third flow connection 36 may comprise a filter and/or a valve, for example in a cap, to prevent dirt and moisture from entering the spring brake cylinder 4 from the outside.

Also, when the spring brake chamber 15 is depressurized, the volume of the spring chamber 16 increases and thereby a third air flow is generated which passes through the first flow connection 33 and the second flow connection 35.

The operation of the breathing device may then be described by way of example as follows:

For example, as described above, when the service brake chamber 19 is pressurized, the breathing valve 28 assumes the closed position so that no compressed air can pass from the service brake chamber 19 into the first return spring chamber 24a. On the other hand, the volume of the first return spring chamber 24a is reduced by the shifting or moving service brake piston 18, thereby creating a first air flow which then passes the second flow connection 35 and the third flow connection 36 to enter the atmosphere. Then, no excess pressure in the first return spring chamber 24a can impede the movement of the service brake piston 18 in the service brake application direction.

On the other hand, when the service brake chamber 19 is depressurized, the return spring 25 urges the service brake piston 18 to move back, where the volume of the first return spring chamber 24a increases what would normally create a vacuum there. But then, as described above, the breathing valve 28 can then assume the open position in which a first flow connection 33 through the through opening between the service brake chamber 19 and the first return spring chamber 24a is open due to the bias of the spring 31. As such, air can pass from the service brake chamber 19 into the first return spring chamber 24a. Then, no vacuum in the first return spring chamber 24a can impede the movement of the service brake piston 18 in the service brake release direction.

When the spring brake chamber 15 is pressurized to release the spring brake, the volume of the spring chamber 16 is reduced, thereby creating a second air flow which can then pass through the third flow connection 36 to enter the atmosphere. Then, no excess pressure in the spring chamber 16 can impede the movement of the spring brake piston 10 in the parking brake release direction.

On the other hand, if the volume of the spring chamber 16 increases when the spring brake chamber 15 is vented to apply the spring or parking brake, air can be drawn in from the outside through the third flow connection 36 as a result of the pressure drop that then occurs, in order to provide pressure equalization there.

FIG. 8 shows a cross-sectional view of a preferred embodiment of a combined service brake and spring brake cylinder of an electro-pneumatic brake system of a commercial vehicle according to a second aspect. In FIG. 8, the same reference numbers as in FIGS. 1 to 7 are given for identical and identically acting parts and components.

Like in the first aspect, the service brake cylinder is pot-shaped and has a cylindrical wall part 37 extending in parallel into the spring brake cylinder housing 11 and a (here second) bottom part 23b connected with the cylindrical wall part 37. Also, the service brake piston 18 is displaceably guided directly on the radially inner circumferential surface of the cylindrical wall part 37 of the service brake cylinder 6.

But in contrast to the embodiment of the first aspect, the second bottom part 23b of the service brake cylinder 6 forms a bottom or a cover of the spring brake cylinder housing 11. Further, according to the second aspect, the service brake chamber (19) is delimited by the service brake piston 18, by the cylindrical wall part of the service brake cylinder 6, and by the second bottom part 23b of the service brake cylinder 6. Also, the service brake piston 18 contacts the second bottom part 23b of the service brake cylinder 6 in the service brake release position, where the service brake is released.

According to the second aspect, there is a second return spring chamber 24b which houses the return spring 25 which loads the service brake piston 18 into the service brake release position is formed between the service brake piston 18 and the spring brake piston 10. Also, there is the first actuating element 8 of the emergency release device 9 which here protrudes a central opening of the second bottom part 23b of the service brake cylinder 6. Here, the accumulator spring 3 is supported on one side on the spring brake piston 10 and on the other side on the second bottom part 23b of the service brake cylinder 6. Further, here, the second bottom part 23b of the service brake cylinder 6 is provided with the second compressed air port 5 for the service brake chamber 19.

Like in the first aspect, preferably a breathing device is provided, which comprises, for example, the breathing valve 28 which is arranged here also preferably in a through-opening of the service brake piston 18 and is controlled by the service brake pressure in the service brake chamber 19. Further, also the first, the second and the third flow connections are provided in the second aspect of the invention. For the description of the function of this breathing device, reference is therefore made to the first aspect. Also, all other functions of the combined service brake and spring brake cylinder according to the second aspect are the same as in the first aspect.

### LIST OF REFERENCE SIGNS

1 combined service brake and spring brake cylinder
2 first compressed air port
3 accumulator spring
4 spring brake cylinder
5 second compressed air port
6 service brake cylinder
7 second actuating element
8 first actuating element
9 emergency release device
10 spring brake piston
11 spring brake cylinder housing
12 first cover
13 second cover
14 first movement seal
15 spring brake chamber
16 spring chamber
17 service brake cylinder housing
18 service brake piston
19 service brake chamber
20 second movement seal
21 edge service brake cylinder
22 service brake piston rod
23a first bottom part
23b second bottom part
24a first return spring chamber
24b second return spring chamber
25 return spring
26 bearing
27 radial protrusion
28 breathing valve
29 valve main body
30 valve seat
31 spring
32 valve body
33 first flow connection
34 sealing section
35 second flow connection
36 third flow connection
37 cylindrical wall part
38 gap
39 recess

1.-29. (canceled)

30. A combined service brake and spring brake cylinder for operating a service brake and a parking brake, comprising:
a spring brake cylinder including
a spring brake cylinder housing,
a spring brake piston, and
at least one accumulator spring loading the spring brake piston in a direction of application of the parking brake, wherein the spring brake piston is displaceably guided on a radially inner circumferential surface of the spring brake cylinder housing, and the spring brake piston and the spring brake cylinder housing delimit a spring brake chamber which can be pressurized by a parking brake pressure;
a separate service brake cylinder; and
a service brake piston, at least the service brake piston delimiting a service brake chamber which can be pressurized with a service brake pressure, wherein the service brake cylinder, viewed radially, is arranged inside the spring brake cylinder housing, wherein the service brake piston is connected to a service brake piston rod, wherein the service brake cylinder is pot-shaped and has a cylindrical wall part extending in parallel into the spring brake cylinder housing and a bottom part proximate to the spring brake piston and further connected with the cylindrical wall part, wherein the service brake piston is displaceably guided directly on the radially inner circumferential surface of the cylindrical wall part of the service brake cylinder, and wherein the bottom part of the service brake cylinder is provided with a central opening through which the service brake piston rod projects.

31. The combined service brake and spring brake cylinder according to claim 30, wherein the service brake chamber is delimited by the service brake piston, by the cylindrical wall part of the service brake cylinder and by a first cover of the spring brake cylinder.

32. The combined service brake and spring brake cylinder according to claim 31, wherein there is a first actuating element of an emergency release device which protrudes a central opening of the first cover.

33. The combined service brake and spring brake cylinder according to claim 31, wherein the first cover has an air port for the service brake chamber.

34. The combined service brake and spring brake cylinder according to claim 30, wherein the spring brake piston contacts the bottom part of the service brake cylinder in a parking brake release position, where the parking brake is released.

35. The combined service brake and spring brake cylinder according to claim 30, wherein a first return spring chamber which houses a return spring which loads the service brake piston into the service brake release position is formed between the service brake piston and the bottom part of the service brake cylinder.

36. A combined service brake and spring brake cylinder for operating a service brake and a parking brake, comprising:
a spring brake cylinder including
a spring brake cylinder housing,
a spring brake piston and
at least one accumulator spring loading the spring brake piston in a direction of application of the parking brake, wherein the spring brake piston is displaceably guided on a radially inner circumferential surface of the spring brake cylinder housing, and the spring brake piston and the spring brake cylinder housing delimit a spring brake chamber which can be pressurized by a parking brake pressure;
a separate service brake cylinder; and
a service brake piston, at least the service brake piston delimiting a service brake chamber which can be pressurized with a service brake pressure, wherein the service brake cylinder, viewed radially, is arranged inside the spring brake cylinder housing, wherein the service brake piston is connected to a service brake piston rod, characterized in that that the service brake cylinder is pot-shaped and has a cylindrical wall part extending in parallel into the spring brake cylinder housing and a bottom part proximate to the service brake piston connected with the cylindrical wall part, the service brake piston is displaceably guided directly on the radially inner circumferential surface of the cylindrical wall part of the service brake cylinder, and where the bottom part of the service brake cylinder forms a at least one of a bottom and a cover of the spring brake cylinder housing.

37. The combined service brake and spring brake cylinder according to claim 36, wherein the service brake chamber is delimited by the service brake piston, by the cylindrical wall part of the service brake cylinder, and by the bottom part of the service brake cylinder.

38. The combined service brake and spring brake cylinder according to claim 36, wherein the service brake piston contacts the bottom part of the service brake cylinder in the service brake release position, where the service brake is released.

39. The combined service brake and spring brake cylinder according to claim 36, wherein a second return spring chamber which houses a return spring which loads the service brake piston into the service brake release position is formed between the service brake piston and the spring brake piston.

40. The combined service brake and spring brake cylinder according to claim 36, wherein there is a first actuating element of an emergency release device which protrudes a central opening of the bottom part of the service brake cylinder.

41. The combined service brake and spring brake cylinder according to claim 36, wherein at least one accumulator spring is supported on one side on the spring brake piston and on the other side on the bottom part of the service brake cylinder.

42. The combined service brake and spring brake cylinder according to claim 39, wherein the bottom part of the service brake cylinder has an air port for the service brake chamber.

43. The combined service brake and spring brake cylinder according to claim 30, wherein the service brake piston rod actuates the service brake when the service brake chamber is pressurized and which releases the service brake when the service brake chamber is vented.

44. The combined service brake and spring brake cylinder according to claim 30, wherein the service brake cylinder has an edge which is connected with the spring brake cylinder housing.

45. The combined service brake and spring brake cylinder according to claim 30, wherein the spring brake piston has a central opening with a bearing through which at least one of the spring brake piston is axially guided on the service brake piston rod and through which the service brake piston rod and the spring brake piston are axially displaceable relative to one another.

46. The combined service brake and spring brake cylinder according to claim 45, wherein the service brake piston rod has, in particular on its radially outer circumference, a radial projection which forms an axial stop for the spring brake piston.

47. The combined service brake and spring brake cylinder according to claim 45, wherein the radial projection is arranged and formed on the service brake piston rod in such a way that at least one of
the spring brake piston brings the service brake piston rod into the applied position of the parking brake by abutment against the radial projection when the spring brake chamber is vented, and
the radial projection comes out of engagement with the spring brake piston and thereby the service brake piston rod is brought into the applied position of the service brake when the spring brake chamber and the service brake chamber are pressurized, and
the spring brake piston by abutting against the radial projection and the service brake piston bring the service brake piston rod into the applied position of the parking brake and the service brake when the spring brake chamber is vented and when the service brake chamber is pressurized.

48. The combined service brake and spring brake cylinder according to claim 45, wherein the spring brake piston, seen radially, extends from the central opening beyond a radially outer circumferential surface of the service brake cylinder to the radially inner circumferential surface of the spring brake cylinder.

49. The combined service brake and spring brake cylinder according to claim 30, wherein between the radially outer circumferential surface of the service brake cylinder and the spring brake cylinder a spring chamber is formed as an annular chamber in which the at least one accumulator spring is arranged.

50. The combined service brake and spring brake cylinder according to claim 30, wherein a breathing device is provided comprising at least a breathing valve which is arranged in a through-opening of the service brake piston and is controlled by the service brake pressure in the service brake chamber in such a way that it assumes an open position when the service brake chamber is vented, in which a first flow connection between the service brake chamber and the return spring chamber is open, and it is brought from the open position into a closed position, in which the first flow connection is blocked, when the service brake chamber is pressurized.

51. The combined service brake and spring brake cylinder according to claim 50, wherein the breathing valve comprises a valve seat and a valve body biased by spring means away from the valve seat in to the open position of the breathing valve, which valve body is urged against the valve seat by the service brake pressure against the action of the spring means to move the breathing valve from the open position to the closed position.

52. The combined service brake and spring brake cylinder according to claim 50, wherein the breathing device comprising further a second flow connection between the return spring chamber and the spring chamber and a third flow connection between the spring chamber and the atmosphere.

53. The combined service brake and spring brake cylinder according to claim 52, wherein when the service brake chamber is pressurized, the volume of the return spring chamber is reduced and thereby a first air flow is generated which passes the second flow connection and the third flow connection.

54. The combined service brake and spring brake cylinder according to claim 52, wherein when the spring brake chamber is pressurized, the volume of the spring chamber is reduced and thereby a second air flow is generated which passes through at least one of the third flow connection and through the first flow connection.

55. The combined service brake and spring brake cylinder according to claim 52, wherein when the spring brake chamber is depressurized, the volume of the spring chamber increases and thereby a third air flow is generated which passes through the first flow connection and the second flow connection.

56. The combined service brake and spring brake cylinder according to claim 30, wherein there is a second actuating element at a first end of the service brake piston rod, that extends through at least one of an opening of the spring brake cylinder housing and through a second cover of the spring brake cylinder housing, wherein the second actuating element is provided to actuate a brake caliper and wherein a second end of the service brake piston rod is connected to the service brake piston.

57. The combined service brake and spring brake cylinder according to claim 56, wherein the second actuating element is pivotally received in a recess at the first end of the service brake piston rod.

58. The combined service brake and spring brake cylinder according to claim 30, wherein at least one of a pneumatic and electro-pneumatic vehicle brake comprises at least one combined service brake and spring brake cylinder.
